(19) United States
(12) Patent Application Publication
(10) Pub. No.: US 2013/0037604 A1
(43) Pub. Date: Feb. 14, 2013

(54) SYSTEM AND METHOD FOR FORMING A REINFORCED BOX STRUCTURE

(71) Applicant: Stuart Goldman, Dollard-des-Ormeaux (CA)

(72) Inventor: Stuart Goldman, Dollard-des-Ormeaux (CA)

(21) Appl. No.: 13/584,283

(22) Filed: Aug. 13, 2012

Related U.S. Application Data
(60) Provisional application No. 61/522,709, filed on Aug. 12, 2011.

(51) Int. Cl. B26D 5/42; B31B 3/00

(52) U.S. Cl. 229/198.2; 493/162

(57) ABSTRACT

The present invention relates to reinforced box structures. A blank for forming a pre-stiffened box structure is provided. The blank comprises a box portion having a base and side panels for providing a box structure, a stiffening panel extending integrally from a given one of the side panels, and a line of weakness delimiting the stiffening panel from said given side panel. The blank is operable into a pre-stiffened configuration wherein the given side panel is folded to position the stiffening panel to substantially overlap and be secured to the base of the box portion. When the folded side panel is pivoted about the line of weakness, a free end of the side panel is biased away from the secured stiffening panel and thereby separates from the stiffening panel along the line of weakness.

### FIELD OF THE INVENTION

The present invention relates to reinforced box structures. More particularly, the present invention relates to a blank for forming a reinforced box structure, to a pre-stiffened collapsed assembly for forming a reinforced box structure, to a reinforced box structure made from the same, as well as to a method of assembling a pre-stiffened collapsed assembly and to a method of deploying the same.

### BACKGROUND OF THE INVENTION

Known in the art are various open-top boxes made of carton, paperboard or the like, which generally serve as a box or a lid for a similarly shaped box. Such open-top boxes generally have a rectangular base wall and four side walls erected on the base. More particularly, there are boxes known as “double-wall” or “simplex” type, which have a single-wall base and four double-wall sides. Such a box is mounted by folding up four side flaps around a base and folding-in an extension on each side flap to form the double wall. A more rigid box is a “set-up” box, used for example as a jewellery box. Such boxes are rigid boxes having the four corners glued with tape, and then wrapped around. However, such boxes do not fold flat and are expensive to produce.

Also known in the art are reinforced simplex boxes, which are less expensive to manufacture than set-up boxes, and offer more rigidity than a normal simplex box. A reinforced simplex box is generally produced by providing a normal simplex box (i.e. single-wall base and double-wall sides), which may be flattened for shipping, and upon assembling the box, a stiffener is added onto the base. For example, a corrugated board or a stiff 60 or 80-point craft board may be hand-glued onto the base, inside the box. However, once the box is stiffened, it cannot be folded back flat, and therefore, the stiffener may be introduced no sooner than at the time of assembly.

Known to the Applicant are U.S. Pat. Nos. 1,906,622 (KONDOLF); 2,203,084 (EVANS); 3,286,900 (KEITH); 3,638,852 (SOLANKA); 3,730,416 (PILZ, III); 4,214,695 (COOPER); 4,339,069 (POTEET); 4,373,660 (WYTKO); 4,550,853 (GRATI); 4,712,726 (FONAS); 5,295,631 (McCLURE); 5,421,509 (THUIN et al.); 5,850,964 (ROSENBAUM et al.); 5,927,593 (BERKOWITZ et al.); 6,427,907 B1 (ESPINOZA et al.); 6,530,516 B1 (RITTER); 7,210,614 B2 (MAZUREK, Richard); and United States Patent Applications No.: 2001/0046930 A1 (TOTH et al.); 2005/0029336 A1 (WENDE); 2005/0092821 A1 (MAZUREK); 2007/0235513 A1 (MAZUREK); 2008/0035717 A1 (TURVEY et al.); 2010/0006632 A1 (CONROY).

Hence, in light of the aforementioned, there is a need for an improved system which, by virtue of its design and components, would be able to overcome some of the above-discussed prior art concerns.

### SUMMARY OF THE INVENTION

The object of the present invention is to provide a device which, by virtue of its design and components, satisfies some of the above-mentioned needs and is thus an improvement over other related box systems and/or methods known in the prior art.

In accordance with the present invention, the above mentioned object is achieved, as will be easily understood, by a blank for forming a reinforced box such as the one briefly described herein and such as the one exemplified in the accompanying drawings.

According to an aspect of the present invention, there is provided a method of assembling a pre-stiffened collapsed assembly to be deployed into a reinforced box structure, the method comprising the steps of:
a) providing a blank comprising:
   a box portion having a base for providing a base of a box structure and side panels extending about the base for providing side walls of the box structure, each side panel having a base end connected to the base and an opposed free end;
   a stiffening panel extending integrally from a given one of said side panels, along the free end thereof; and
   a line of weakness delimiting the stiffening panel from the free end of said given side panel;
b) folding said given side panel so as to position the stiffening panel in a stiffening position wherein the stiffening panel substantially overlaps the base of the box portion, the folded side panel being pivotable about the line of weakness to provide a side wall of the box structure at deployment, whereby the free end shifts with respect to the base of the box portion; and
c) securing the stiffening panel to the base in said stiffening position for stiffening the box structure, so as to substantially separate the stiffening panel from the given side panel along the line of weakness, when the folded side panel is pivoted about the line of weakness and thereby biases the free end away from the stiffening panel.

Preferably, the folded side panel in the pre-stiffened collapsed assembly provided at step (a), is configured in a collapsed configuration wherein said folded side panel is pivoted about the line of weakness and is substantially collapsed over the secured stiffener and thereby biasing the free end away from the secured stiffening panel, the secured stiffening panel thereby being substantially separated from the folded side panel.

Preferably, the pivoting of step (b) comprises substantially separating the secured stiffening panel from the folded side panel along the line of weakness via the biasing action of step (b).

According to another aspect of the present invention, there is provided a method of deploying a pre-stiffened collapsed assembly into a reinforced box structure, the method comprising the steps of:
a) providing a pre-stiffened collapsed assembly comprising:
   a collapsed assembly having a base for providing a base of a box structure and side panels extending about the base for providing side walls of the box structure, each side panel having a base end connected to the base and an opposed free end;
   a stiffening panel adjacent a given one of the side panels, along the free end thereof; and
   a line of weakness delimiting the stiffening panel from the free end of the side panel;
said side panel being folded to position the stiffening panel in a stiffening position wherein the stiffening panel substantially overlaps the base of the box portion,
the stiffening panel being secured to the base in said stiffening position;
b) pivoting the folded side panel of the pre-stiffened collapsed assembly about the line of weakness toward a raised configuration, wherein the folded side panel is substantially erect with respect to the base so as to provide a corresponding one of said sidewalls of the box structure, thereby biasing the free end away from the stiffening panel and leaving the stiffening panel secured to the base and substantially separated from said folded side panel; and
c) raising remaining ones of the side panels of the pre-stiffened collapsed assembly for forming respective ones of said side walls of the box structure.

According to another aspect of the present invention, there is provided a reinforced box structure deployed in accordance with the above-method. The box structure deployed may be a container and/or a lid for a container.

According to another aspect of the present invention, there is provided a pre-stiffened collapsed assembly for forming a reinforced box, the pre-stiffened collapsed assembly comprising:
a collapsed assembly having a base for providing a base of a box structure and side panels extending about the base for providing side walls of the box structure, each side panel having a base end connected to the base and an opposed free end;
a stiffening panel adjacent a given one of the side panels, along the free end thereof; and
a line of weakness delimiting the stiffening panel from the free end of the side panel;
   said side panel being folded to position the stiffening panel in a stiffening position wherein the stiffening panel substantially overlaps the base of the box portion,
   the stiffening panel being secured to the base in said stiffening position,
   the collapsed assembly being operable in a deployed configuration wherein the folded side panel is substantially erect with respect to the base so as to provide a corresponding one of said sidewalls of the box structure at deployment, thereby biasing the free end away from the stiffening panel, leaving the stiffening panel secured to the base and substantially separated from the folded side panel, and wherein remaining ones of the side panels of the pre-stiffened collapsed assembly are raised for providing respective ones of said side walls of the box structure.

Preferably, the folded side panel is configured in a collapsed configuration wherein said folded side panel is pivoted about the line of weakness and is substantially collapsed over the secured stiffener, thereby biasing the free end away from the secured stiffening panel, the secured stiffening panel thereby being substantially separated from the folded side panel.

According to another aspect of the present invention, there is provided a blank for forming a reinforced box structure, the blank comprising:
a box portion having a base for providing a base of a box structure and side panels extending about the base for providing side walls of the box structure, each side panel having a base end connected to the base and an opposed free end;
a stiffening panel extending integrally from a given one of the side panels, along the free end thereof and
a line of weakness delimiting the stiffening panel from the free end of said given side panel;
   the blank being operable between a planar configuration wherein the box portion and stiffening panel extend substantially along a same plane, and a pre-stiffened configuration wherein the given side panel is folded to position the stiffening panel in a stiffening position where the stiffening panel substantially overlaps the base of the box portion and is further secured to the base in said stiffening position, the folded side panel being pivotable about the line of weakness to provide a corresponding one of said sidewalls of the box structure at deployment, thereby biasing the free end away from the secured stiffening panel and substantially separating the folded side panel from the stiffening panel along the line of weakness.

According to another aspect of the present invention, there is provided a blank for forming a reinforced box, the blank comprising:
a main body portion having a base and side flaps for forming a main body of a box; and
a stiffener extending integrally from one of the side flaps, to be folded in alignment with the base of the main body portion and to be secured thereto and folding-in the side flap over the stiffener, so as to form a pre-stiffened collapsed assembly,
the stiffener being detachable from the main body portion along a line of weakness, such that when the pre-stiffened collapsed assembly is deployed to form the box, a back-shift motion of the side flap being raised creates a tear along the line of weakness, leaving the stiffener adhered to the base of the box.

The adjoining edges of the portions of the blank provided on each side of the line of weakness are separated by a space when positioned according to the box being in a deployed configuration. This separation, in combination with the stiffener being secured to the base, causes the line of weakness to tear when unfolding of the side wall into a raised position.

In other words, there is provided a blank for forming a box, the blank comprising:
a main body portion for forming a body of the box; and
an extension being integrally made with the main body portion and separated from the main body portion by a line of weakness to detach therefrom, the extension being operable between a folded configuration wherein the extension is folded against the base of the main body and adhered thereto to provide a stiffener for the base, and a detached configuration wherein the stiffener detaches from the main body portion upon erecting the box.

According to yet another aspect of the present invention, there is provided a pre-stiffened collapsed assembly for forming a reinforced box, the pre-stiffened collapsed assembly comprising:
a collapsed main body portion having a base and side flaps attached to the base for forming a main body of a box; and
a stiffener attached to one of the side flaps by a line of weakness, the stiffener being folded in alignment with the base of the main body portion and secured thereto, the corresponding side-flap being folded-in over the stiffener,
wherein the stiffener is detachable from the main body portion along the line of weakness, such that when the corresponding side flap is raised away from the base to form a side wall of a box, the line of weakness tears, leaving the stiffener adhered to the base of the box.

By “line of weakness” it is meant a line portion on the blank being formed to tear easily, when subjected to a pulling tension. Accordingly, the “line of weakness” may be provided by a cut-score crease, a suitable line of perforations, a scoring rule resulting in a partial slit, etc., and/or any combination thereof which facilitates detaching the stiffener from the main body.

It is to be understood also that, in the context of the present invention “box” or “box structure” may refer to a box-shaped article such as a base of a box, a lid to be fitted over a box, etc. To form a reinforced lid according to embodiments of the present invention, a construction similar to that for making the base may be provided, but with different dimensions, in order to fit about the base of the box or inside the base of the box, for example.

According to another aspect of the present invention, there is provided method for manufacturing the above-mentioned blank.

The objects, advantages and features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1 is a plan view of a die-cut blank for forming a box according to an embodiment of the present invention, the blank being shown in a planer unassembled configuration.

FIG. 2A is a schematic representation of a portion of the blank shown in FIG. 1, at a given step of a method for assembling a pre-stiffened collapsed assembly, in accordance with an embodiment of the present invention.

FIG. 2B is a schematic representation of the portion of the blank shown in FIG. 2A, at another step of the method for assembling a pre-stiffened collapsed assembly.

FIG. 2C is a schematic representation of the portion of the blank shown in FIG. 2A, at another step of the method for assembling a pre-stiffened collapsed assembly.

FIG. 2D is a schematic representation of the portion of the blank shown in FIG. 2A, at another step of the method for assembling a pre-stiffened collapsed assembly.

FIG. 3 is a plan view of a die-cut blank for forming a box according to an embodiment of the present invention, the blank being shown in an initial unassembled configuration.

FIG. 4 is a plan view of the blank shown in FIG. 3, the blank being shown in accordance with a first step of a method of assembling the blank into a pre-stiffened collapsed assembly, in accordance with an embodiment of the present invention.

FIG. 5 is a plan view of the blank shown in FIG. 4, in accordance with a second step of the method.

FIG. 6 is a plan view of the blank shown in FIG. 5, in accordance with a third step of the method.

FIG. 7 is a plan view of the blank shown in FIG. 6, in accordance with a fourth step of the method.

FIG. 8 is a plan view of the blank shown in FIG. 7, in accordance with a fifth step of the method, showing the completely folded and glued pre-stiffened collapsed assembly.

FIG. 9 is a plan view of the partially assembled and deployed pre-stiffened collapsed assembly shown in FIG. 8, in accordance with a first step of a method of deploying the pre-stiffened collapsed assembly into a reinforced box structure.

FIG. 10A is a cross-sectional side view of one of the end flap of the assembly shown in FIG. 9, taken inside the partially assembled and deployed reinforced box structure along line XA-XA, in accordance with a second step of the method.

FIG. 10B is a cross-sectional side view of the opposite end flap of the assembly shown in FIG. 9, taken inside the partially assembled and deployed reinforced box structure along line XB-XB, in accordance with the third step of the method.

FIG. 11A is another cross-sectional side view of the same end flap of the assembly as shown in FIG. 10A, taken inside the completely assembled and deployed reinforced box structure along line XA-XA, in accordance with an fourth step of the method.

FIG. 11B is another cross-sectional side view of the same end flap of the assembly as shown in FIG. 10B, taken inside the completely assembled and deployed reinforced box structure along line XB-XB, in accordance with the fifth step of the method.

FIG. 12 is a plan view of the completely assembled and deployed reinforced box structure, in accordance with a sixth step of the method, showing the box structure.

FIG. 13 is a perspective view of the box structure shown in FIG. 12.

### DETAILED DESCRIPTION OF PREFERRED EMBODIMENTS OF THE INVENTION

In the following description, the same numerical references refer to similar elements. The embodiments, geometrical configurations, materials mentioned and/or dimensions shown in the figures or described in the present description are preferred embodiments only, given for exemplification purposes only.

In the context of the present invention, the expressions “stiffener”, “extension”, “reinforced panel” and any other equivalent expression and/or compound words thereof known in the art will be used interchangeably. Furthermore, the same applies for any other mutually equivalent expressions, as can be understood by a person skilled in the art.

Moreover, although the preferred embodiment of the present invention as illustrated in the accompanying drawings comprises components such as four side walls, inner and outer portions of the sidewalls, a rectangular base, corner webs, narrow extensions, locking tabs, etc., and although the preferred embodiment of blank and corresponding parts thereof consists of certain geometrical configurations as explained and illustrated herein, not all of these components and geometries are essential to the invention and thus should not be taken in their restrictive sense, i.e. should not be taken as to limit the scope of the present invention. It is to be understood, as also apparent to a person skilled in the art, that other suitable components and cooperations thereinbetween, as well as other suitable geometrical configurations may be used for the pre-stiffened collapsed assembly, the blank and/or the reinforced box, according to the present invention, as will be briefly explained herein and as can be easily inferred herefrom, by a person skilled in the art, without departing from the scope of the invention.

Furthermore, the order of the steps of the method described herein should not be taken as to limit the scope of the invention, as the sequence of the steps may vary in a number of ways, without affecting the scope or working of the invention, as can also be understood.

Broadly described, and as better shown in the accompanying drawings, there is provided a blank for forming a paperboard box having sidewalls and a base wall, wherein the base wall is reinforced with a stiffener, which is initially provided integrally with the blank.

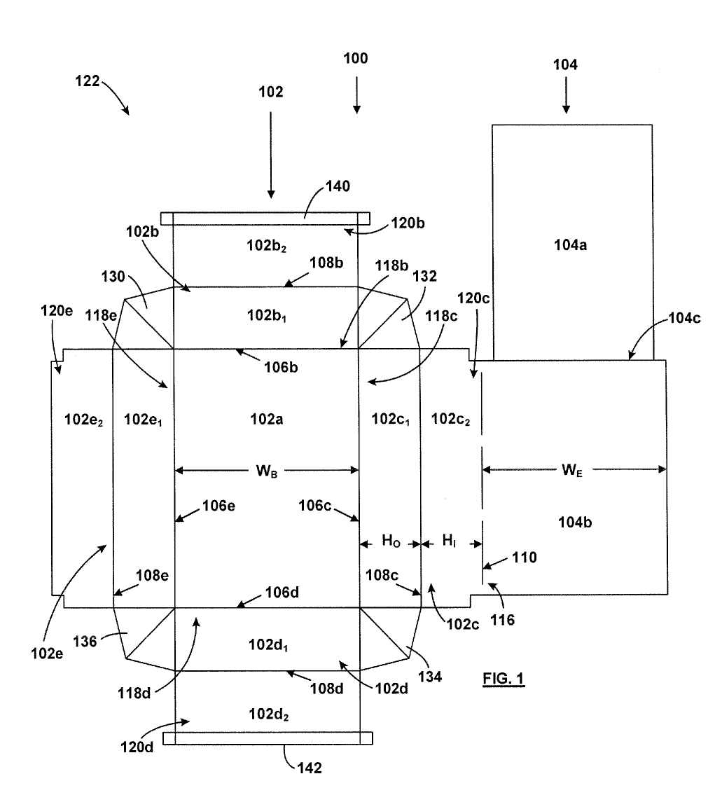

More particularly, with reference to FIG. 1, there is provided a paperboard blank (100) for forming a box (114) (also referred to herein as “box structure”). The blank (100) has a main body portion (102) (also referred to herein as “box portion”) and an extension (104) (also referred to herein as “stiffening panel”) which is detachably connected to the main body portion (102), preferably with a cut-score crease (110). The main body portion (102) is shaped and configured to form the main body of a box, such as a normal simplex type box, for example. The extension (104) is positioned to correspond to the base of the box when the blank (100) is folded-up to form the box.

Preferably, the main body is defined by a base portion (102a) for forming the base of the box and by side flaps (102b, 102c, 102d, 102e), for forming the sides of the box. The extension is connected to one of the flaps, namely 102c, and comprises a first area (104a) and a second area (104b).

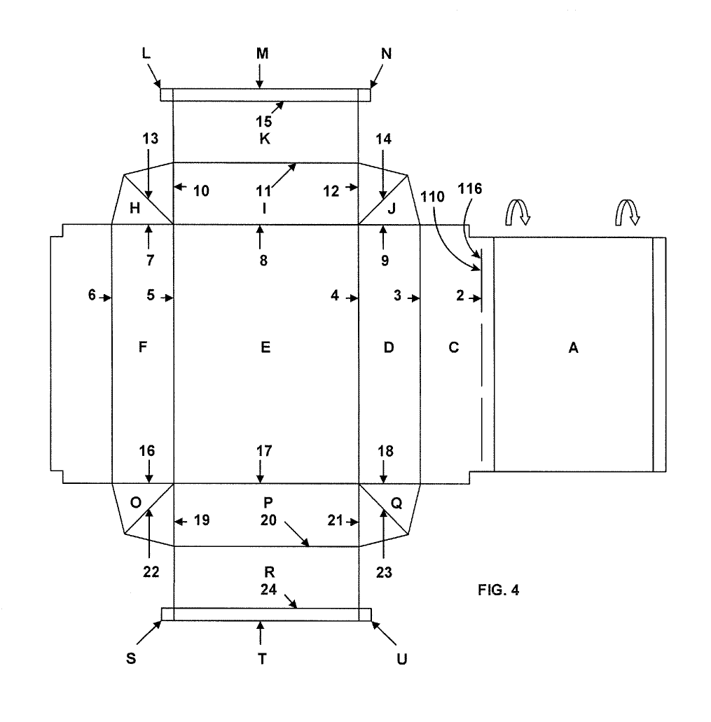

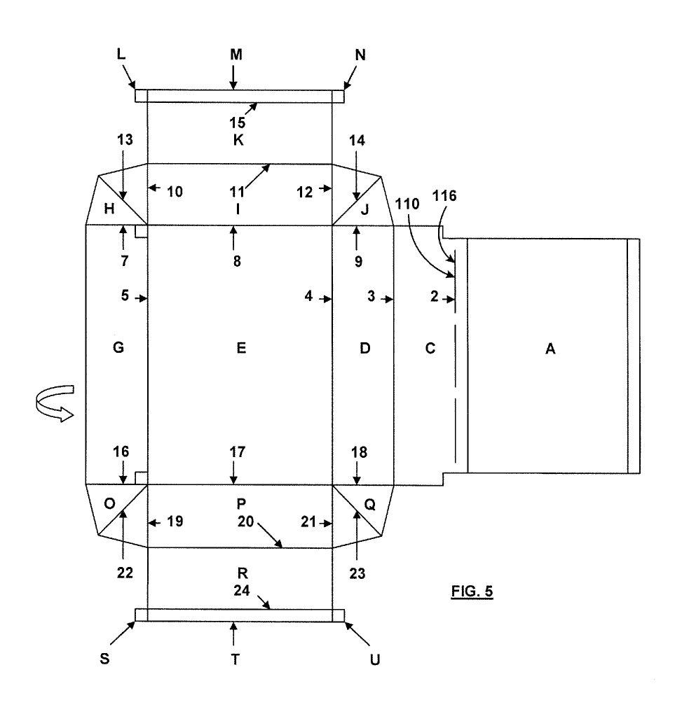

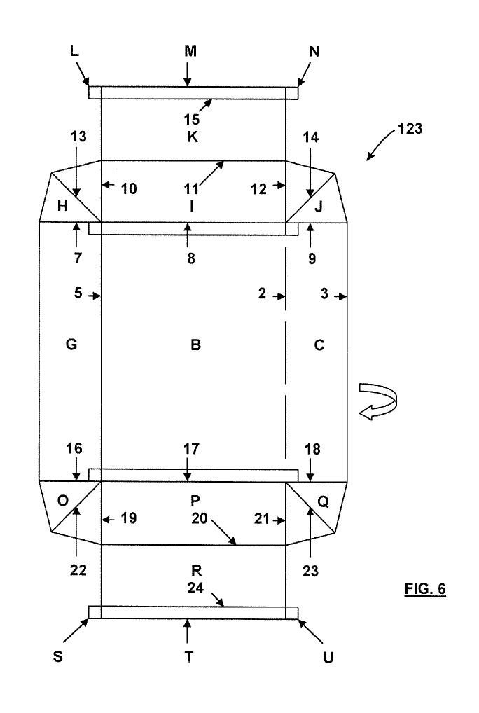

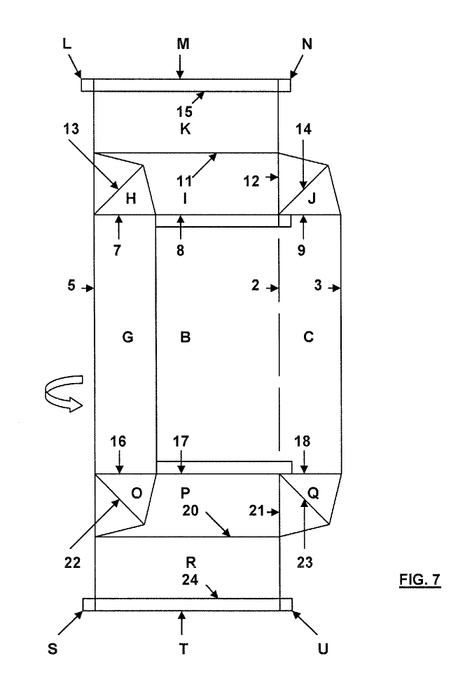

To assemble the box, the first area (104a) of the extension is folded over a second area (104b) and secured thereto, thereby forming a double layered extension (104) as shown in FIG. 4. This double layered component will form the stiffener when adhered to the base (102a) of the box. Each inner wall portion (102c₂ and 102e₂) of long flaps (102c and 102e) is folded upwardly and inwardly along fold lines (108c and 108e, respectively) against the adjacent outer wall portion (102c₁ and 102e₁, respectively) and secured thereto as shown in FIGS. 5 and 6. Being attached to the inner flap (102c₂), the double layered extension (104) is also folded upwardly and inwardly along fold line (108c) against the base portion (102a) and secured thereto. Thus, the extension (104) is positioned to correspond with the base (102a). The two double-walled sides (102c and 102e) are then folded upwardly and inwardly along fold lines (106c and 106e, respectively) to form the long double-walled sides of the box as shown in FIGS. 7 and 8.

In other words, the side wall (102c) and the opposing side wall (102e) are folded flat onto the base, to form a “folding carton” (or a “pre-stiffened collapsed assembly”) which can be easily shipped flat.

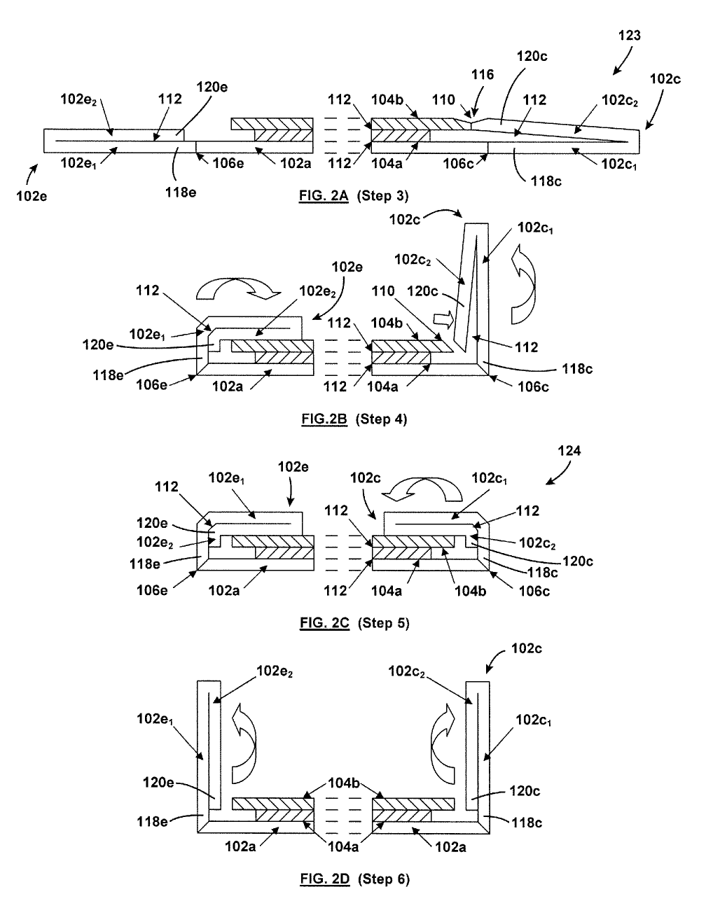

The width of the extension (W_{E}) is slightly less than the width of the base (W_{B}), as schematically illustrated in FIGS. 2A, 2B, 2C and 2D, with further reference to FIG. 1. As also shown, the height (H_{I}) of the inner wall portion of 102c is slightly less than the height (H_{O}) of the outer wall portion of 102c. Thus, the side wall (102c) may be folded in flat onto the base without interference due to the thickness of the blank. The stiffener (104) is coated with an adhesive (112) which secured the stiffener (104) to the base (102a). Upon folding in the side wall (102c) upwardly and inwardly against the base (102a), the bottom edge of the inner wall 102c₂, which extends along crease (110), shifts away from the glued extension (104), as shown in FIGS. 2B and 2C. As a consequence, the cut-score crease (110) tears, so as to detach the bottom edge of the inner wall 102c₂ from the glued double layered extension (104). Thus, the collapsed assembly may be deployed into a box by erecting the side walls (102c and 102e), as schematically represented at FIG. 2D, to form a box which already has a stiffener (104) at its base (102a).

In other words, as the folding carton passes through the folder-gluer, namely when the double-sided wall (102c) is folded over the extension (104) as shown in FIGS. 2B and 2C, the bottom edge of the inner portion (102c₂) of the side wall (102c) pulls away from the edge of the top panel (104b) of the extension (104) which is closest to side wall (102c). This pulling action (or biasing force), in combination with the stiffener (104) being secured to the base (102a), causes the line of weakness (110) to tear, which results into a pre-stiffened box assembly, which can be deployed to form a stiffened box.

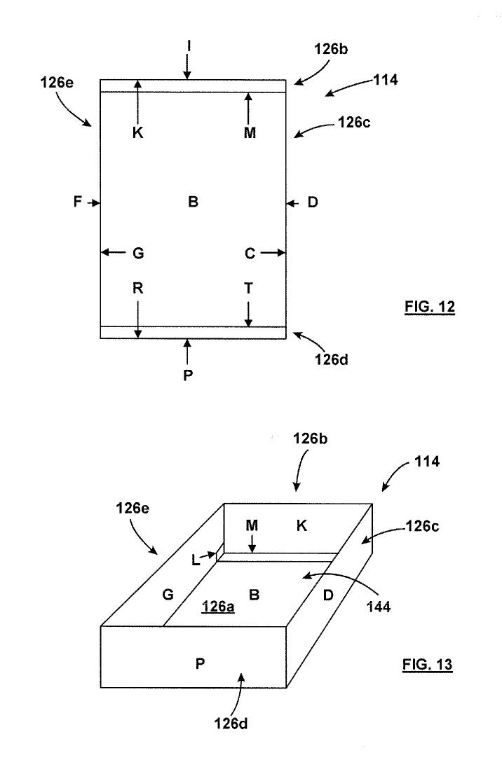

Thus, in other terms, FIG. 1 exemplifies a blank (100) for forming a reinforced box structure (114), as better illustrated in FIGS. 12 and 13. The blank (100) comprises a box portion (102), a stiffening panel (104) and a line of weakness (116), such as cut-score crease (110). The box portion (102) has a base (102a) for providing a base (B) of the box structure (114) and side panels (102b, 102c, 102d, 102e) extending about the base for providing respective side walls (I,D,P,F) of the box structure (114), each side panel (102b, 102c, 102d, 102e) having a base end (118b, 118c, 118d, 118e) connected to the base (102a) and an opposed free end (120b, 120c, 120d, 120e). The stiffening panel (104) extends integrally from a given one (102c) of the side panels, along the free end (120c) thereof. The line of weakness (116) delimits the stiffening panel (104) from the free end (120c) of the side panel (102c).

The blank (100) is operable in a planar configuration (122), as shown in FIG. 1, wherein the box portion (102) and stiffening panel (104) extend substantially along a same plane. The blank (100) is further operable in a pre-stiffened configuration (124), as better shown in FIG. 8, wherein the given side panel (102c, or “C” in FIG. 7 and “D” in FIG. 8) is folded to position the stiffening panel (104 or “B”) in a stiffening position. In the stiffening position, the stiffening panel (104) substantially overlaps the base (102a) of the box portion (102) and is further secured to the base (102a), as depicted in FIG. 2A and FIG. 6. The folded side panel (102c) is pivotable about the line of weakness (116) to provide a corresponding one of said sidewalls of the box structure (114) at deployment, thereby biasing the free end (120c) away from the secured stiffening panel (104) and substantially separating the folded side panel (102c) from the stiffening panel (104) along the line of weakness (116), as better illustrated in FIGS. 2B and 2C. Indeed, the pivotal movement of the side panel (102c) causes the free end (120c) to move with respect to the base (102), and therefore when the stiffening panel is secured to the base (102), the line of weakness is subjected to tension when the free end is biased away from the stiffening panel (104) which causes the line of weakness to tear.

It is to be understood that the line of weakness may tear fully or only partially, at different degrees, depending on the pivotal movement of the side panel (102c), and depending on the thickness of the blank and components of the blank, as well as their rigidity, etc.

As previously mentioned, the line of weakness (116) in the exemplified embodiment is a cut-score crease (110). Alternatively, the line of weakness may be provided by a suitable line of perforations, a scoring rule resulting in a partial slit, etc., and/or any combination thereof which facilitates detaching the stiffener (104) from the side panel (102c).

As can be seen in the drawings, the stiffening panel (104) is sized to substantially cover the base (102a). Moreover, the stiffening panel (104) of the blank (100) comprises a main panel (104b) extending directly from the given side panel (102c) and an extension panel (104a) extending from the main panel (104b). The stiffening panel (104) comprising a fold line (104c) between the extension panel (104a) and the main panel (104b), in order to fold the extension panel (104a) over the main panel (104b). Furthermore, at least one of the main panel (104b) and extension panel (104a) comprise adhesive (112) in order to adhere the extension panel (104a) with the main panel (104b).

Furthermore, at least one of the stiffening panel (104) and the base (102a) of the box portion (102) comprises adhesive in order to secure the stiffening panel (104) to the base (102a).

Furthermore, the side panel (102c) comprises a fold line (108c) extending substantially centrally between the free end (120c) and the base end (118c), in order to position the stiffening panel (104) in said stiffening position (123), as better shown in FIGS. 2A and 6, with reference also to FIG. 1.

As can be seen, the side panels (102b, 102c, 102d, 102e) each comprises a fold line (108b, 108c, 108d, 108e, respectively) extending substantially centrally between the free end (120b, 120c, 120d, 120e, respectively) and the base end (118b, 118c, 118d, 118e, respectively), in order to form when folded a double layered side wall (126a, 126b, 126c, 126d) for the box structure (114), as better illustrated in FIGS. 12 and 13.

As can be seen also, the base (102a) is substantially rectangular. The side panels comprise two length side panels (102c, 102e) extending from opposing sides of the base (102a) and two end side panels (102b, 102d) extending from other opposing ends of the base (102a). The blank (100) comprises a fold line (106b, 106c, 106d, 106e) between the base (102a) and each of said side panels (102b, 102c, 102d, 102e, respectively) in order to raise the side panels (102b, 102c, 102d, 102e) about the base (102a) to provide corresponding walls (126a, 126b, 126c, 126d) for the box structure (114) at deployment.

As previously mentioned, each of the side panels (102b, 102c, 102d, 102e) comprises a center fold line (108b, 108c, 108d, 108e) extending substantially centrally between the free end (120b, 120c, 120d, 120e) and the base end (118b, 118c, 118d, 118e), dividing each of the side panels into a first portion (102b₁, 102c₁, 102d₁, 102e₁) extending directly from the base (102a) and a second portion (102b₂, 102c₂, 102d₂, 102e₂) extending from the first portion opposite the base. The second portion (102b₂, 102c₂, 102d₂, 102e₂) is foldable inwardly about the center fold line (108b, 108c, 108d, 108e) in order to provide a double layered side wall (126a, 126b, 126c, 126d) when the box structure (114) is deployed.

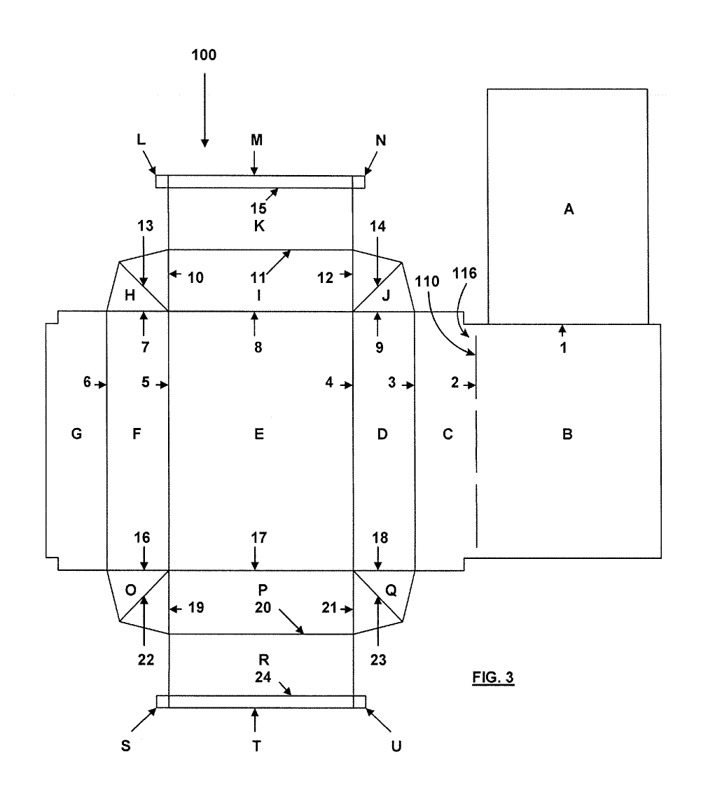

As shown in FIG. 1, with further reference to FIG. 3, four corner flaps (130, 132, 134, 136) are connected between adjacent first portions (102b₁, 102c₁, 102d₁, 102e₁) of the side flaps and comprising fold lines (13, 14, 22, 23) as better shown in FIG. 3 in order to be folded inwardly for joining the adjacent side walls at deployment of the box structure, as better illustrated in FIGS. 10A and 10B.

Furthermore, a narrow locking extension (140, 142) with a small locking tab extending at each end, respectively, extends from each of the end side panels (102b, 102d) and being delimited by a corresponding fold line (15, 24), as better shown in FIG. 3. The narrow locking extensions (140, 142) are foldable along the fold lines (15, 24) at deployment of the box structure in order to lock the side walls (126a, 126b, 126c, 126d) in a raised configuration, as better shown in FIGS. 12 and 13.

Furthermore, the blank (100) preferably comprises cardboard material.

The steps for assembling the box according to a preferred embodiment of the invention will now be explained with more detail, with reference to FIGS. 3 to 13.

### Folding and Gluing Steps 1-5

FIG. 3 shows the blank (100) in an initial unassembled configuration.

It is to be understood that the components in FIGS. 3 to 13 correspond to similar components in FIG. 1. Namely:
panel “A” corresponds to extension panel (104a);
panel “B” corresponds to main panel (104b);
panel “E” corresponds to base (102a);
panel “I” corresponds to the first portion of the end side panel (102b);
panel “D” corresponds to the first portion of the length side panel (102c);
panel “P” corresponds to the first portion of the end side panel (102d);
panel “F” corresponds to the first portion of the length side panel (102e);
panel “K” corresponds to the second portion of the end side panel (102b);
panel “C” corresponds to the second portion of the length side panel (102c);
panel “R” corresponds to the second portion of the end side panel (102db);
panel “G” corresponds to the second portion of the length side panel (102e);
panel “H” corresponds to corner flap panel (130);
panel “J” corresponds to corner flap panel (132);
panel “Q” corresponds to corner flap panel (134);
panel “O” corresponds to corner flap panel (136);
panel “M” corresponds to locking tab (140);
panel “T” corresponds to locking tab (142);
fold line 1 in FIGS. 3 to 13 corresponds to fold line 104c in FIG. 1;
fold line 2 in FIGS. 3 to 13 corresponds to crease 110 or line of weakness 116 in FIG. 1;
fold line 3 in FIGS. 3 to 13 corresponds to fold line 108c in FIG. 1;
fold line 4 in FIGS. 3 to 13 corresponds to fold line 106c in FIG. 1;
fold line 5 in FIGS. 3 to 13 corresponds to fold line 106e in FIG. 1;
fold line 6 in FIGS. 3 to 13 corresponds to fold line 108e in FIG. 1;
fold line 8 in FIGS. 3 to 13 corresponds to fold line 106b in FIG. 1;
fold line 11 in FIGS. 3 to 13 corresponds to fold line 108b in FIG. 1;
fold line 17 in FIGS. 3 to 13 corresponds to fold line 106d in FIG. 1; and
fold line 20 in FIGS. 3 to 13 corresponds to fold line 108d in FIG. 1.

Step 1 (see FIG. 4): Panel A uncoated side is folded around Crease 1 towards the uncoated side of Panel B to be glued to said Panel B uncoated side.

Step 2 (see FIG. 5): Panel G uncoated side is folded around Crease 6 towards the uncoated side of Panel F to be glued to said Panel F uncoated side.

Step 3 (see FIG. 6): Panel A coated side and Panel C uncoated side are folded together around Crease 3 towards the uncoated side of Panel E and the uncoated side of Panel D, respectively, to be glued to said Panel E uncoated side and said Panel D uncoated side, respectively.

Step 4 (see FIG. 7): Panel G coated side with Web Corner H uncoated side and Web Corner O uncoated side are folded together around Creases 5, 10 and 19, respectively, towards the coated side of Panel B and the uncoated sides of Panel I and Panel P, respectively. At the same time, the section of the uncoated side of Corner Web H, located between the Crease 13 (diagonal perforation) and the Crease 10, is glued to said uncoated side of Panel I and the section of the Corner Web O, located between the Crease 22 (diagonal perforation) and the Crease 19, is glued to said uncoated side of Panel P.

Step 5 (see FIG. 8): Panel C coated side with Web Corner J uncoated side and Web Corner Q uncoated side are folded together around Creases 4, 12 and 21, respectively, towards the coated side of Panel B and the uncoated sides of Panel I and Panel P, respectively. At the same time, the section of the uncoated side of Corner Web J, located between the Crease 14 (diagonal perforation) and the Crease 12, is glued to said uncoated side of Panel I and the section of the Corner Web Q, located between the Crease 23 (diagonal perforation) and the Crease 21, is glued to said uncoated side of Panel P. At this step, the weakened Crease 2 (Cut and perforation) is broken (or in some cases partially broken, or weakened) by the folding action of Panel C against Panel B, leaving the double layered assembly (Panel A and Panel B) glued to the resulting reinforced Panel E, as previously mentioned with reference to FIGS. 1 and 2A to 2D. This is the last step of the manufacturing process.

### Erecting Steps 6-9

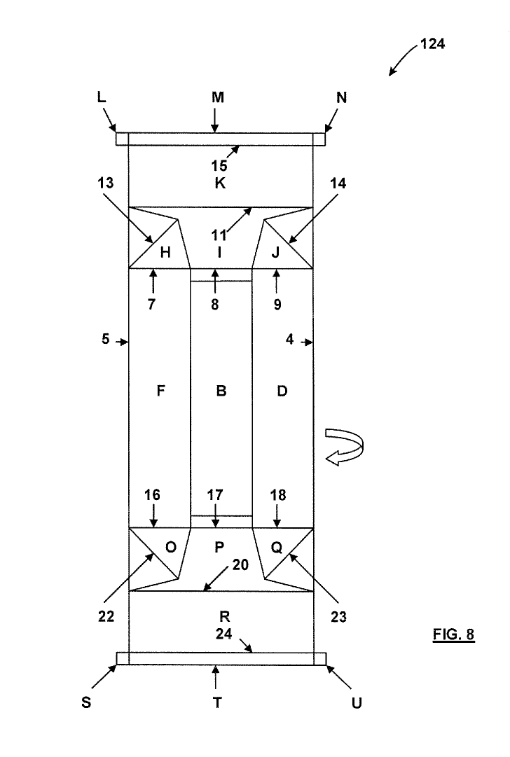

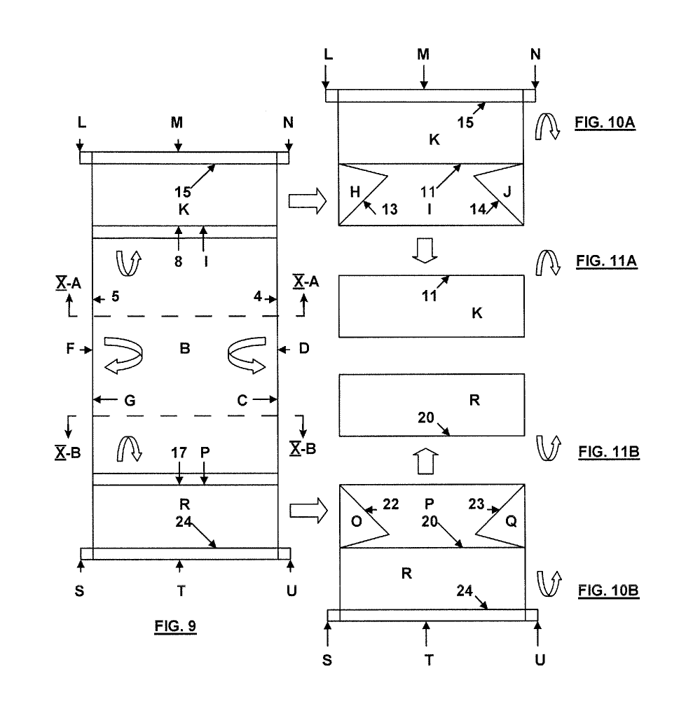

Step 6 (see FIG. 9): To erect the box base or lid, the two (2) longer side panels, namely Panel F and Panel D are moved upwards, simultaneously, to a vertical position. Consequently, the two (2) smaller end panels, namely Panel I and Panel P, being glued to the web corners of said Panel F and said Panel D, respectively, will also be moved upwards, automatically and simultaneously, to a vertical position, with Panel K and Panel R extending, respectively, from said Panel I and said Panel P. If the Crease 2 (Cut and perforation) has not yet been torn or is not fully torn, the moving upwards of Panel C, into a vertical position, will break the weakened Crease 2, leaving the double layered assembly (Panel A and Panel B) glued to the resulting reinforced Panel E.

Step 7 (see FIGS. 10A and 10B): The extending panels, namely Panel K and Panel R, are pushed towards the inside of the base or lid, around Crease 11 and Crease 20, respectively, against the Corner Web H and Corner Web J, previously glued to Panel I and Corner Web O and Corner Web Q, previously glued to Panel P, respectively.

Step 8 (see FIGS. 11A and 11B): When the Panel K is pressed down against the bottom (Panel B), the narrow locking extension (Panel M) and the two (2) small Locking Tabs L and N are inserted automatically in the openings provided between the Panel B and Crease 8 and those provided at the bottom of Panel G close to Crease 7 and at the bottom of Panel C close to Crease 9, respectively. Similarly, when the Panel R is pressed down against the bottom (Panel B), the narrow lockingextension (Panel T) and the two (2) small Locking Tabs S and U are inserted automatically in the openings provided between the Panel B and Crease 17 and those provided at the bottom of Panel G close to Crease 16 and at the bottom of Panel C close to Crease 18, respectively.

Step 9 (see FIG. 12): Top inside view of the erected reinforced box (Base or Lid) with all Panels identified and isometric view (see FIG. 13) of the erected reinforced box (Base or Lid) with all Panels identified.

FIG. 13 shows the resulting erected box (114).

Thus in other terms, the method of assembling a pre-stiffened collapsed assembly (124) (see FIG. 8) to be deployed into a reinforced box structure (114) (see FIG. 13), the method comprises the following steps (with numeric references of FIG. 1):
a) providing a blank (100), as shown in FIG. 3 comprising (with reference to FIGS. 1, 8 and 13):
   a box portion (102) having a base (102a) for providing a base (126a) of a box structure (114) and side panels (102b, 102c, 102d, 102e) extending about the base (102a) for providing side walls (126b, 126c, 126d, 126e) of the box structure (114), each side panel (102b, 102c, 102d, 102e) having a base end (118b, 118c, 118d, 118e) connected to the base (102a) and an opposed free end (120b, 120c, 120d, 120e);
   a stiffening panel (104) extending integrally from a given one (102c) of said side panels, along the free end (120c) thereof, wherein the stiffening panel (104) comprises a main panel (104b) and an extension panel (104a) extending from the main panel (104b), and wherein the given side wall (102c) comprises a center fold line (108c) extending substantially centrally between the free end (120c) and the base end (118c) of said given side wall (102c); and
   a line of weakness (116) delimiting the stiffening panel (104) from the free end (120c) of said given side panel (102c);
b) (i) folding the extension panel (104a) over the main panel (104b) along the fold line (104c), as illustrated in FIG. 4; (ii) adhering the extension panel to the main panel, also represented in FIG. 4; and (iii) folding said given side panel (102c) about the center fold line (108c) so as to readily position the stiffening panel (104) in a stiffening position (123), as better illustrated in FIG. 6, wherein the stiffening panel (104) substantially overlaps the base (102a) of the box portion (102) to substantially overlap an inner side of the base, corresponding to an inner side (144) of the box structure (114) when deployed (see FIG. 13);
c) (i) securing and more particularly, adhering, the stiffening panel to the base in said stiffening position for stiffening the box structure, as represented in FIG. 6, and (ii) securing the free end (120c) of the folded side wall (102c) to the base end (118c), as also represented in FIG. 6;
d) pivoting the folded side panel about the line of weakness toward a collapsed configuration (124), as represented in FIG. 8, and as better illustrated in FIGS. 2B and 2C, wherein the folded side panel (102c) is substantially collapsed over the secured stiffener (104), the pivotal movement of the folded side panel (102c) about the line of weakness (116) causing the free end (120c) to shift with respect to the base (102a) of the box portion (102) (see FIG. 2B), and thereby biases the free end (120c) away from the stiffening panel (104), so as to tear the blank along the line of weakness (116); and
e) configuring remaining ones (102b, 102d, 102e) of the side walls, as represented in FIGS. 5, 6, 7 and 8, in order to be deployed (or erected) into corresponding side walls (126b, 126d, 126e) of the box structure (114), shown in FIG. 13.

Preferably, the blank is made of a 24-point cardboard, so as to provide a 48-point stiffener. Thus, when the box is assembled and the extension is mounted on the base, the resulting box has a triple-walled base (i.e. 72-point thickness).

It is to be understood that, depending on the particular embodiment, after completing the above-mentioned Step 5 (illustrated in FIG. 8, as well as FIGS. 2B and 2C), crease (110) may be fully torn, partially torn or still remain intact (not yet torn). Indeed, for example based on the freshness of the adhesive which glues the extension (104) to the base (102a), the stiffener may still be movable and thus remain connected to the side wall (102c), or at least partially connected (i.e. some fibers connecting the two panels). If the crease is not yet torn or only partially torn, the tearing will be completed at Step 6 (illustrated in FIG. 9, as well as FIG. 2D), when the side wall (102c) is erected upon deploying the collapsed assembly to form the box (shown in FIG. 13).

The present invention is particularly advantageous in that the blank may be entirely glued and assembled in an automatic production line, to form a pre-assembled “folding carton” which may be shipped flat. For example, the folding carton may be manufactured according to the above-mentioned steps 1 to 5, such that the stiffener is pre-glued onto the base. When the folding carton is folded open to form the box, for example, according to the above-mentioned steps 6 to 9, the stiffener is already assembled to the base and preferably completely breaks away from the sidewall upon the unfolding action, resulting in a box having a stiffened base.

The present invention is particularly advantageous in that there is no need for a stiffener to be provided separately nor for manual gluing of the stiffener in a subsequent step. Instead, the stiffener is part of the box, since the extension is made integral with the main body portion of the blank. Moreover, the stiffener is pre-glued to the base, in order to provide a pre-stiffened collapsed assembly which may be shipped flat and readily deployed to form a reinforced box.

Thus, the present invention is concerned with an improved system and method for providing a folding carton which may be reinforced by an automated manufacturing process and which may be folded flat for shipping, prior to assembly into a stiffened box (also known as “set-up box”).

Several modifications may be made to the above-described blank, collapsed assembly or reinforced box system and/or method for making the same, without departing from the scope of the present invention, as can be easily understood by a person skilled in the art. Indeed and for example, different suitable adhesive methods may be used, as required. For example, when referring to FIG. 4, side E may be coated with adhesive while side A may not. Alternatively, both sides may be coated with adhesive. The same applies for any two surfaces to be secured together. Moreover, any suitable adhesive may be used or mechanical securing means may be used (for example a hook and loop material, etc.), as can be understood by a person skilled in the art. Moreover, the components of the blank may be interconnected and secured in a variety of ways without departing from the scope of the present invention.

Several modifications may be made to the above-described blank, collapsed assembly or reinforced box system and/or method for making the same, without departing from the scope of the present invention, as can be easily understood by a person skilled in the art. Indeed and for example, the main body of the blank may be configured to form a single wall box, having one double wall with a reinforced double wall base. Alternatively, a portion between the outer wall of the box and the stiffener may be removable (along two lines of weakness) resulting in a single wall box, with a stiffened base. The stiffener may be single layered, as can be understood by a person skilled in the art. Moreover, the blank may be shaped and configured such that one or more of the side walls, and/or the stiffener, have any suitable amount of layers, depending on the desired thickness and stiffness of the box. As also apparent to a skilled reader, the blank, the pre-stiffened collapsed assembly and/or the reinforced box may be provided to form a box of any suitable shape and/or size (for example: bases of triangular, pentagonal, hexagonal, etc. shape; a box having a rectangular base with only one, two or three side walls; a box having one or more side wall raised at an angle other than 90 degrees). Moreover, depending on the desired shape of the box, the blank and/or collapsed assembly may be shaped and configured accordingly, i.e. with required fastening or securing means, etc.

Numerous other modifications could be made to the above-described blank, collapsed assembly or reinforced box system and/or method for making the same, without departing from the scope of the present invention. Indeed, the above-described embodiments are considered in all respect only as illustrative and not restrictive, and the present application is intended to cover any adaptations or variations thereof, as apparent to a person skilled in the art.

1. A method of assembling a pre-stiffened collapsed assembly to be deployed into a reinforced box structure, the method comprising the steps of:
a) providing a blank comprising:
a box portion having a base for providing a base of a box structure and side panels extending about the base for providing side walls of the box structure, each side panel having a base end connected to the base and an opposed free end;
a stiffening panel extending integrally from a given one of said side panels, along the free end thereof; and
a line of weakness delimiting the stiffening panel from the free end of said given side panel;
b) folding said given side panel so as to position the stiffening panel in a stiffening position wherein the stiffening panel substantially overlaps the base of the box portion, the folded side panel being pivotable about the line of weakness to provide a side wall of the box structure at deployment, whereby the free end shifts with respect to the base of the box portion; and
c) securing the stiffening panel to the base in said stiffening position for stiffening the box structure, so as to substantially separate the stiffening panel from the given side panel along the line of weakness, when the folded side panel is pivoted about the line of weakness and thereby biases the free end away from the stiffening panel.

2. The method according to claim 1, further comprising:
d) pivoting the folded side panel about the line of weakness toward a collapsed configuration wherein said folded side panel is substantially collapsed over the secured stiffener, thereby tearing the blank provided at step (a) along the line of weakness.

3. The method according to claim 1, wherein the stiffening panel of the blank comprises a main panel and an extension panel extending from the main panel, the method further comprising before step (b): folding the extension panel over the main panel.

4. The method according to claim 3, further comprising adhering the extension panel to the main panel.

5. The method according to claim 1, wherein the given side wall of the blank provided at step (a) comprises a fold line extending substantially centrally between the free end and the base end of said given side wall, and wherein the folding of step (b) is made along said fold line.

6. The method according to claim 1, wherein the folding of step (b) positions the stiffening panel to substantially overlap an inner side of the base, corresponding to an inner side of the box structure when deployed.

7. The method according to claim 1, wherein the securing of step (c) comprises adhering the stiffening panel to the base of the box portion.

8. The method according to claim 1, further comprising after step (b), securing the free end of the folded side wall to the base end.

9. The method according to claim 1, further comprising configuring remaining ones of said side walls to be deployed into corresponding side walls of the box structure.

10. The method according to claim 1, wherein all the steps are executed by an automatic manufacturing process.

11. A method of deploying a pre-stiffened collapsed assembly into a reinforced box structure, the method comprising the steps of:
a) providing a pre-stiffened collapsed assembly comprising:
a collapsed assembly having a base for providing a base of a box structure and side panels extending about the base for providing side walls of the box structure, each side panel having a base end connected to the base and an opposed free end;
a stiffening panel adjacent a given one of the side panels, along the free end thereof; and
a line of weakness delimiting the stiffening panel from the free end of the side panel;
said side panel being folded to position the stiffening panel in a stiffening position wherein the stiffening panel substantially overlaps the base of the box portion,
the stiffening panel being secured to the base in said stiffening position;
b) pivoting the folded side panel of the pre-stiffened collapsed assembly about the line of weakness toward a raised configuration, wherein the folded side panel is substantially erect with respect to the base so as to provide a corresponding one of said sidewalls of the box structure, thereby biasing the free end away from the stiffening panel and leaving the stiffening panel secured to the base and substantially separated from said folded side panel; and
c) raising remaining ones of the side panels of the pre-stiffened collapsed assembly for forming respective ones of said side walls of the box structure.

12. The method according to claim 11, wherein the folded side panel in the pre-stiffened collapsed assembly provided at step (a), is configured in a collapsed configuration wherein said folded side panel is pivoted about the line of weakness and is substantially collapsed over the secured stiffener and thereby biasing the free end away from the secured stiffening panel, the secured stiffening panel thereby being substantially separated from the folded side panel.

13. The method according to claim 11, wherein the pivoting of step (b) comprises substantially separating the secured stiffening panel from the folded side panel along the line of weakness via the biasing action of step (b).

14. A reinforced box structure deployed in accordance with the method of claim 11.

15. A reinforced box structure according to claim 14, wherein the box structure deployed is a container or a lid for a container.

16. A pre-stiffened collapsed assembly for forming a reinforced box, the pre-stiffened collapsed assembly comprising:
a collapsed assembly having a base for providing a base of a box structure and side panels extending about the base for providing side walls of the box structure, each side panel having a base end connected to the base and an opposed free end;
a stiffening panel adjacent a given one of the side panels, along the free end thereof; and
a line of weakness delimiting the stiffening panel from the free end of the side panel;
said side panel being folded to position the stiffening panel in a stiffening position wherein the stiffening panel substantially overlaps the base of the box portion,
the stiffening panel being secured to the base in said stiffening position,
the collapsed assembly being operable in a deployed configuration wherein the folded side panel is substantially erect with respect to the base so as to provide a corresponding one of said sidewalls of the box structure at deployment, thereby biasing the free end away from the stiffening panel, leaving the stiffening panel secured to the base and substantially separated from the folded side panel, and wherein remaining ones of the side panels of the pre-stiffened collapsed assembly are raised for providing respective ones of said side walls of the box structure.

17. The pre-stiffened collapsed assembly according to claim 16, wherein the folded side panel is configured in a collapsed configuration wherein said folded side panel is pivoted about the line of weakness and is substantially collapsed over the secured stiffener, thereby biasing the free end away from the secured stiffening panel, the secured stiffening panel thereby being substantially separated from the folded side panel.

18. A blank for forming a reinforced box structure, the blank comprising:
a box portion having a base for providing a base of a box structure and side panels extending about the base for providing side walls of the box structure, each side panel having a base end connected to the base and an opposed free end;
a stiffening panel extending integrally from a given one of the side panels, along the free end thereof and
a line of weakness delimiting the stiffening panel from the free end of said given side panel;
the blank being operable between a planar configuration wherein the box portion and stiffening panel extend substantially along a same plane, and a pre-stiffened configuration wherein the given side panel is folded to position the stiffening panel in a stiffening position where the stiffening panel substantially overlaps the base of the box portion and is further secured to the base in said stiffening position, the folded side panel being pivotable about the line of weakness to provide a corresponding one of said sidewalls of the box structure at deployment, thereby biasing the free end away from the secured stiffening panel and substantially separating the folded side panel from the stiffening panel along the line of weakness.

19. The blank according to claim 18, wherein the stiffening panel of the blank is sized to substantially cover the base.

20. The blank according to claim 18, wherein the stiffening panel of the blank comprises a main panel extending directly from the given side panel and an extension panel extending from the main panel, the stiffening panel comprising a fold line between the extension panel and the main panel, in order to fold the extension panel over the main panel.

21. The blank according to claim 20, wherein at least one of the main panel and extension panel comprise adhesive in order to adhere the extension panel with the main panel.

22. The blank according to claim 18, wherein at least one of the stiffening panel and the base of the box portion comprises adhesive in order to secure the stiffening panel to the base.

23. The blank according to claim 18, wherein the line of weakness is a cut-score crease.

24. The blank according to claim 18, wherein the blank comprises cardboard material.

25. The blank according to claim 18, wherein said given side panel comprises a fold line extending substantially centrally between the free end and the base end, in order to position the stiffening panel in said stiffening position.

26. The blank according to claim 18, wherein one or more of the side panels each comprises a fold line extending substantially centrally between the free end and the base end, in order to form when folded a double layered side wall for the box structure.

27. The blank according to claim 18, wherein the base is substantially rectangular and wherein the side panels comprise two length side panels extending from opposing sides of the base and two end side panels extending from other opposing ends of the base, the blank comprising a fold line between the base and each of said side panels in order to raise the side panels about the base to provide corresponding walls for the box structure at deployment.

28. The blank according to claim 27, wherein each of the side panels comprises a center fold line extending substantially centrally between the free end and the base end, dividing each of the side panels into a first portion extending directly from the base and a second portion extending from the first portion opposite the base, the second portion being foldable inwardly about the center fold line in order to provide a double layered side wall when the box structure is deployed.

29. The blank according to claim 28, further comprising four corner flaps, each being connected between adjacent first portions of the side flaps and comprising fold lines in order to be folded inwardly for joining the adjacent side walls at deployment of the box structure.

30. The blank according to claim 29, wherein the corner flaps are each adapted to be adhered to an adjacent one of the end side flaps, in order to form a pre-assembled collapsed box structure.

31. The blank according to claim 28, further comprising a locking extension extending from each of the end side panels and two locking tabs extending at opposing ends of each locking extension, the locking extensions being operable at deployment to fold against the base of the box in order to lock the side walls in a raised configuration.
